(19) United States
(12) Patent Application Publication
(10) Pub. No.: US 2021/0376891 A1
(43) Pub. Date: Dec. 2, 2021

(54) ELECTRONIC DEVICE AND METHOD FOR INDOOR POSITIONING

(71) Applicant: Quanta Computer Inc., Taoyuan City (TW)

(72) Inventors: Cheng-Yang TSENG, Taoyuan City (TW); Po-Shan KAO, Taoyuan City (TW); Jia-Yang TSAO, Taoyuan City (TW); Yan-Cheng CHANG, Taoyuan City (TW)

(21) Appl. No.: 17/014,424

(22) Filed: Sep. 8, 2020

(30) Foreign Application Priority Data
Jun. 1, 2020 (TW) 109118235

(51) Int. Cl. H04B 7/06; H04B 7/08; H01Q 3/26

(52) U.S. Cl. CPC H04B 7/0617; H01Q 3/2605; H04B 7/086

(57) ABSTRACT

An electronic device for indoor positioning includes an array antenna and a processor. The array antenna includes a plurality of antenna units. The array antenna receives a wireless signal transmitted from user equipment. Each of the antenna units receives the reception parameters of the wireless signal. The processor executes the following tasks: dividing the antenna units into a plurality of groups; combining the reception parameters of the antenna units included in each of the groups to generate a reception parameter matrix; and calculating a plurality of angles of arrival (AOA) from the UE to the plurality of the groups according to the reception parameter matrix.

### CROSS REFERENCE TO RELATED APPLICATIONS

This application claims priority to and the benefit of Taiwan Application No. 109118235, filed on Jun. 1, 2020, the entirety of which is incorporated by reference herein.

### FIELD OF THE INVENTION

The invention relates to an electronic device, especially one relating to an electronic device and a method for indoor positioning.

### DESCRIPTION OF THE RELATED ART

With the evolution and popularization of the Bluetooth Low Energy (BLE) standard, many system services have been developed for positioning-related applications. In terms of positioning accuracy, due to the characteristics of Bluetooth radio frequency signal, the traditional positioning error achieved by using the received signal strength (RSSI) may reach several meters. The “direction finding” function newly added in the latest Bluetooth standard 5.1 only defines the standard framework of angle of arrival, such as the packet format and the sampling mode of the RF antenna, but there is no certain standard for software and hardware implementation of angle of arrival and angle estimation algorithm.

To estimate the direction-of-arrival of a signal, Multiple signal classification (MUSIC) method is the most typical algorithm with the highest resolution. The MUSIC method separates a signal subspace and a noise subspace by analyzing the difference of the signal space characteristics, and according to the orthogonality of the above two subspaces, the MUSIC method can obtain the direction-of-arrival of the signal. However, the above method must meet the conditions to obtain excellent estimation results, such as sufficient quantity of antennas, good signal-to-noise ratio (SNR), sufficient quantity of antenna samples, signal sources not related to each other, etc. In addition, the large amount of calculation is also a shortcoming of the traditional MUSIC algorithm, which causes an efficiency bottleneck in positioning applications that require immediate calculation.

### BRIEF SUMMARY OF THE INVENTION

In order to resolve the issue described above, an embodiment of the invention provides an electronic device. The electronic device includes an array antenna and processor. The array antenna includes a plurality of antenna units to receive a wireless signal transmitted from user equipment (UE). The processor executes the following tasks: dividing the antenna units into a plurality of groups; combining the reception parameters of sampling data the antenna units included in each of the groups to generate a reception parameter matrix of sampling data; providing a multiple signal classification (MUSIC) module; and calculating a plurality of angles of arrival (AOA) from the UE to the plurality of each of the groups according to the reception parameter matrix.

An embodiment of the invention provides a method for indoor positioning, applicable to an electronic device comprising an array antenna and a processor, wherein the array antenna comprises a plurality of antenna units. The method comprises the following steps: receiving a wireless signal transmitted from user equipment (UE), wherein each of the antenna units receives the reception parameters from sampling of the wireless signal; dividing the antenna units into a plurality of groups; combining the reception parameters of the antenna units included in each of the groups to generate a reception parameter matrix; and calculating a plurality of angles of arrival (AOA) from the UE to the antenna units of each of the groups according to the reception parameter matrix.

### BRIEF DESCRIPTION OF THE DRAWINGS

The invention can be more fully understood by reading the subsequent detailed description with references made to the accompanying figures. It should be understood that the figures are not drawn to scale in accordance with standard practice in the industry. In fact, it is allowed to arbitrarily enlarge or reduce the size of components for clear illustration.

FIG. 1 shows a schematic diagram of an indoor positioning system in accordance with some embodiments of the disclosure.

FIG. 2 shows a schematic diagram of an indoor positioner in accordance with some embodiments of the disclosure.

FIG. 3 shows a schematic diagram of an array antenna of the indoor positioner in accordance with some embodiments of the disclosure.

FIG. 4 shows a sampling schematic diagram of an array antenna 200 in FIG. 3 in accordance with some embodiments of the disclosure.

FIG. 5 shows a schematic diagram of filtering a plurality of angles of arrival by a statistic filter in accordance with some embodiments of the disclosure.

FIG. 6 shows a flow chart of an indoor positioning method in accordance with some embodiments of the disclosure.

### DETAILED DESCRIPTION OF THE INVENTION

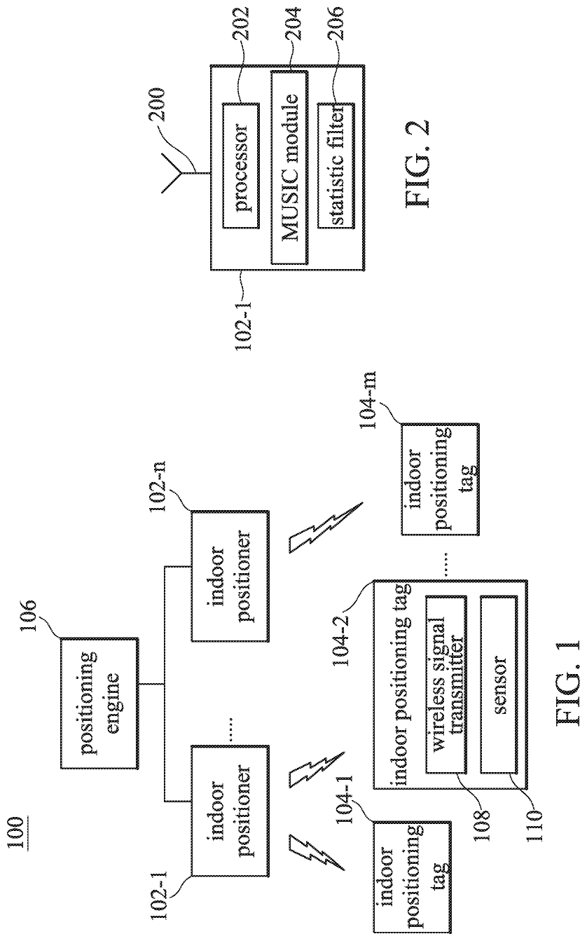

FIG. 1 shows a schematic diagram of an indoor positioning system in accordance with some embodiments of the disclosure. As shown in FIG. 1, an indoor positioning system 100 includes a plurality of indoor positioners 102-1, 102-2, . . . , 102-n, a plurality of indoor positioning tags 104-1, 104-2, . . . , 104-m, and a positioning engine 106. In some embodiments, the indoor positioners 102-1, 102-2, . . . , 102-n may be arranged in different locations indoors (for example, in corridors, corners of walkways, stairs, or rooms). Each of the indoor positioners has an array antenna to receive a wireless signal transmitted from the indoor positioning tags 104-1, 104-2, . . . , 104-m. The indoor positioners 102-1, 102-2, . . . , 102-n calculate angles of arrival of each of the indoor positioning tags 104-1, 104-2, . . . , 104-m according to a reception strength and a reception phase of the received wireless signal, and send information of the angles of arrival to the positioning engine 106. The positioning engine 106 calculates and determines a location of each of the indoor positioning tags 104-1, 104-2, . . . , 104-m according to the information of angles of arrival. In some embodiments, the angles of arrival is a 2D angles of arrival (DoA), that is, including an elevation angle and an azimuth angle.

In some embodiments, the indoor positioning tags 104-1, 104-2, . . . , 104-m are arranged on user equipment, for example, arranged on a mobile device worn by a user, or arranged in a personal identification card. The indoor positioning tags 104-1, 104-2, . . . , 104-m follow the user's movement and continuously and periodically transmit wireless signals to the indoor positioners arranged at different locations. Each of the indoor positioning tags 104-1, 104-2, . . . , 104-m, taking the indoor positioning tag 104-2 as an example, has a wireless signal transmitter 108 and a sensor 110. In some embodiments, the wireless signal transmitter 108 periodically transmits Bluetooth beacon. The sensor 110, for example, is an inertial measurement unit (IMU). When the wireless signal transmitter 108 sends out a Bluetooth beacon, the Bluetooth beacon may be sent to the indoor positioner 102-1 together with data of the sensor 110 and received by the array antenna of the indoor positioner 102-1. The data of the sensor 110 could be used to calculate the moving status or the velocity direction (or called status data) of the indoor positioning tag 104-2.

FIG. 2 shows a schematic diagram of an indoor positioner in accordance with some embodiments of the disclosure. As shown in FIG. 2, the indoor positioner 102-1 includes an array antenna 200, a processor 202, a multiple signal classification (MUSIC) module 204, and a statistic filter 206. The array antenna 200 receives a wireless signal transmitted from the indoor positioning tags 104-1, 104-2, . . . , 104-m in FIG. 1. In some embodiments, the wireless signal is a Bluetooth signal (or Bluetooth beacon). Status data of the indoor positioning tags 104-1, 104-2, . . . , 104-m are included in the Bluetooth beacon. The processor 202 determines that whether the indoor positioning tags 104-1, 104-2, . . . , 104-m are in a stationary state or a moving state according to the status data. The processor 202 divides a plurality of antenna units in the array antenna 200 into a plurality of groups, and combines reception parameters of received sampling of the antenna units included in each of the groups to generate a reception parameter matrix of received sampling according to the status of the indoor positioning tags 104-1, 104-2, . . . , 104-m. Then, the processor 202 inputs or sends out the reception parameter matrix of received sampling to the MUSIC module 204 to calculate a plurality of angles of arrival (AOA) from the indoor positioning tags 104-1, 104-2, . . . , 104-m to the antenna units of each of the groups. Finally, the processor 202 sends the angles of arrival calculated out by the MUSIC module 204 to the statistic filter 206 to remove the angles of arrival that suffer multipath interference.

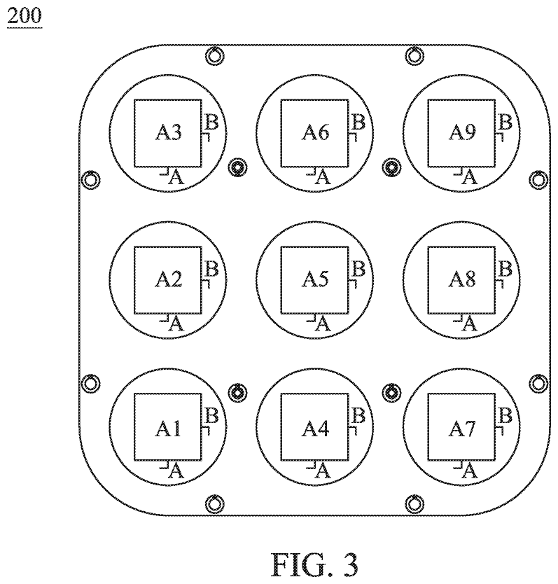

FIG. 3 shows a schematic diagram of an array antenna of the indoor positioner in accordance with some embodiments of the disclosure. As shown in FIG. 3, the array antenna 200 is arranged in each of the indoor positioners 102-1, 102-2, . . . , 102-n in FIG. 1. The array antenna 200 includes a plurality of antenna units, such as antenna units A1, A2, A3, A4, A5, A6, A7, A8, and A9, but the present invention is not limited thereto. Each of the antenna units A1-A9 has two polarization directions, for example, a polarization direction A and a polarization direction B. Each of the indoor positioners 102-1, 102-2, . . . , 102-n may switch the polarization directions of the antenna units A1-A9 (for example, according to the programming setting of a corresponding software). For example, each of the indoor positioners 102-1, 102-2, . . . , 102-n may switch the antenna units A1-A9 to the polarization direction A at a first time, then switch the antenna units A1-A9 to the polarization direction B at a second time after the first time, and then switch the antenna units A1-A9 back to the polarization direction A at a third time after the second time, to increase the number of data from the received wireless signal, wherein the data (for example, including the reception strength and the reception phase) from the received wireless signal are provided as input data to the MUSIC module 204 for subsequent estimation of the angles of arrival of each antenna unit.

In some embodiments, each of the indoor positioners 102-1, 102-2, . . . , 102-n in FIG. 1 sequentially performs IQ sampling on the antenna units A1, A2, A3, A4, A5, A6, A7, A8, and A9 within a standard time.

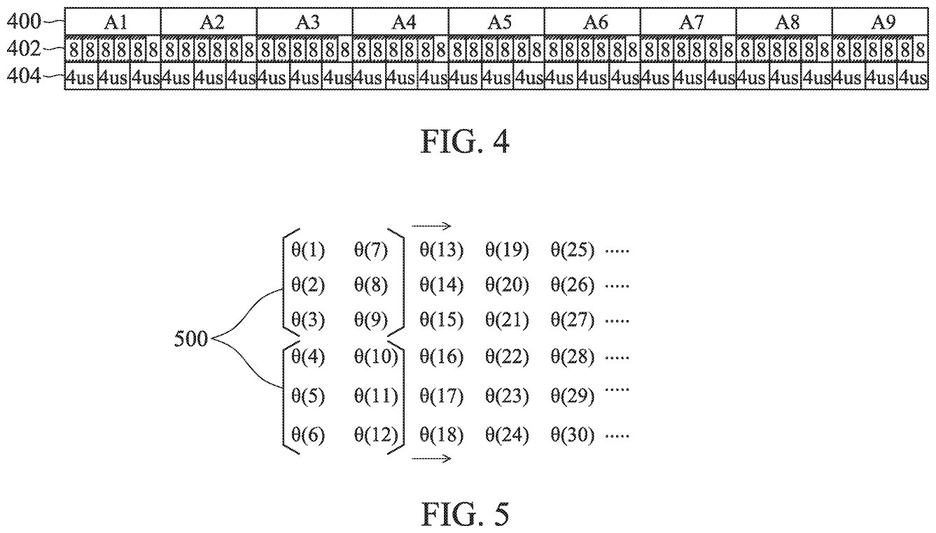

FIG. 4 shows a sampling schematic diagram of an array antenna 200 in FIG. 3 in accordance with some embodiments of the disclosure. Referring to FIGS. 1-4 at the same time, for example, in a first period, the processor 202 of the indoor positioner 102-1 turns on a switch connected to the antenna A1, so that the Bluetooth beacon can be sampled or decoded by the processor 202 of the indoor positioner 102-1. Therefore, the processor 202 may obtain reception parameters (including the reception strength and the reception phase) of the antenna unit A1 and the status data of the indoor positioning tag 104-2. Similarly, in a second period, the processor 202 of the indoor positioner 102-1 turns on a switch connected to the antenna A2, so that the Bluetooth beacon can be sampled by the processor 202 of the indoor positioner 102-1. Therefore, the processor 202 may obtain reception parameters of the antenna unit A2 and the status data of the indoor positioning tag 104-2. After that, the indoor positioner 102-1 sequentially turns on switches connected to the antenna units A3-A9 to obtain reception parameters of the antenna units A3-A9 and the status data of the indoor positioning tag 104-2.

As shown in FIG. 4, in a specific embodiment, each of the antenna units A1-A9 may sample the Bluetooth beacons for a duration (that is, the duration that the indoor positioner 102-1 respectively turns on the corresponding switches connected with the antenna units A1-A9) of 12 μs, and may get 8 samples of data every 2 μs. Each sample of data from Bluetooth beacon includes the reception strength and the reception phase. In FIG. 4, the antenna units A1-A9 listed in the row named sampling antenna unit 400 means that the indoor positioner 102-1 sequentially samples Bluetooth beacons received by the antenna units A1-A9. The row named number of sampling data 402 indicates that the indoor positioner 102-1 samples 48 times in a Bluetooth beacon received from each of the antenna unit A1-A9. The row named sampling time 404 indicates that the indoor positioner 102-1 samples a Bluetooth beacon received by each of the antenna units A1-A9 for 12 μs. According to the number of sampling data 402 and the sampling time 404, it is known that the processor 202 of the indoor positioner 102-1 samples a Bluetooth beacon received by each of the antenna units A1-A9 eight times every 2 μs. Due to hardware factors of switching between antenna units, the IQ sampling data of the last 2 μs of the sampling time slot allocated to each of the antenna units A1-A9 may affect a software calculation result due to interference cause by switching. Therefore, the present invention only uses the sampling data for the first 10 μs, so that the number of IQ sampling data that each of the antenna units can obtain in a single Bluetooth beacon is limited by the system. For example, there are only 8*5=40 samples in FIG. 4. An electronic device and method for indoor positioning provided in the present invention increases the number of IQ sampling data that can be obtained in a single Bluetooth beacon or in a plurality of Bluetooth beacons to increase the accuracy of the MUSIC module 204 for estimating the angles of arrival of the wireless signal received by each of the antenna units.

It is noted that the original IQ sampling data include a coordinate, comprising a real number I and a complex number Q, on a complex plane. The original IQ sampling data need to be converted for calculating the reception strength and the reception phase.

In some embodiments, the function of the MUSIC module is implemented by the processor 202 executing a multiple signal classification (MUSIC) algorithm. The MUSIC module 204 divides the reception parameters (including the reception strength and the reception phase) of IQ sampling data of the antenna units A1-A9 when receiving a Bluetooth beacon into groups, and transfers the reception parameters into a matrix type as its input. The MUSIC module 204 correspondingly outputs the angles of arrival corresponding to the divided group of the antenna units A1-A9 according to the received reception parameters. In some embodiments, the MUSIC module 204 can be executed by another SoC (system on a chip), but the invention is not limited thereto. Generally, the MUSIC algorithm separates a signal subspace and a noise subspace by performing an eigen decomposition on the covariance matrix that calculated from the reception parameter matrix of sampling of the wireless signal and according to the orthogonality between the signal subspace and the noise subspace, the MUSIC algorithm can calculate the angles of arrival from the user equipment to each of the groups of the antenna units.

Generally, the MUSIC algorithm is used in military large-scale array radars for processing tens of thousands to hundreds of thousands of input data, to calculate the position of an object detected by the radar based on the input data. In other words, when the more data is input to the MUSIC algorithm, the angles of arrival (the elevation angle and the azimuth angle) calculated by the MUSIC algorithm is more accurate. Therefore, the present invention may increase the number of sampling data in a single Bluetooth beacon.

In some embodiments, referring to FIGS. 1-3 at the same time, the indoor positioning tag 104-2 loads the status data about its movement status (for example, stationary or moving) into a Bluetooth beacon, and periodically transmits the Bluetooth beacon. After the array antenna 200 of the indoor positioner 102-1 receives the Bluetooth beacon transmitted from the indoor positioning tag 104-2, the processor 202 in the indoor positioner 102-1 first determines the user equipment, where the indoor positioning tag 104-2 is located, is in a stationary status or a moving status. Then, the processor 202 of the indoor positioner 102-1 divides the antenna units A1-A9 of the array antenna 200 into groups. In some embodiments, the processor 202 divides the antenna units into groups in row or in column. For example, the processor 202 divides the antenna units into groups in row (X axis), that is, dividing the antenna units A1, A2 and A3 into a first group, dividing the antenna units A4, A5 and A6 into a second group, and dividing the antenna units A7, A8 and A9 into a third group. For example, the processor 202 divides the antenna units into groups in column (Y axis), that is, dividing the antenna units A1, A4 and A7 into a fourth group, dividing the antenna units A2, A5 and A8 into a fifth group, and dividing the antenna units A3, A6 and A9 into a sixth group, but the present invention does not limit the dividing method.

When the indoor positioner 102-1 determines that the user equipment is in the moving status, the indoor positioner 102-1 generates a reception parameter matrix according to IQ sampling data of the Bluetooth beacon sampled on the antenna units included in each of the groups. For example, the processor 202 of the indoor positioner 102-1 combines the IQ sampling data of the Bluetooth beacon sampled on the antenna units A1, A2, and A3 in the first group to generate a reception parameter matrix (1), as follows.

$$[ \begin{matrix}{M}_{A 1}^{1} & {M}_{A 1}^{2} & ⋯ & {M}_{A 1}^{39} & {M}_{A 1}^{40} \\ {M}_{A 2}^{1} & {M}_{A 2}^{2} & ⋯ & {M}_{A 2}^{39} & {M}_{A 2}^{40} \\ {M}_{A 3}^{1} & {M}_{A 3}^{2} & ⋯ & {M}_{A 3}^{39} & {M}_{A 3}^{40}\end{matrix} ]$$

Wherein M_{A1}¹ indicates 1^{st} IQ sampling data of the Bluetooth beacon received by the antenna unit A1, M_{A2}² indicates 2^{nd} IQ sampling data of the Bluetooth beacon received by the antenna unit A2, and M_{A3}⁴⁰ indicates 40^{th} IQ sampling data of the Bluetooth beacon received by the antenna unit A3.

Similarly, the processor 202 of the indoor positioner 102-1 combines the IQ sampling data of the Bluetooth beacon received by the antenna units A4, A5, and A6 in the second group to generate a reception parameter matrix (2), as follows.

$$[ \begin{matrix}{M}_{A 4}^{1} & {M}_{A 4}^{2} & ⋯ & {M}_{A 4}^{39} & {M}_{A 4}^{40} \\ {M}_{A 5}^{1} & {M}_{A 5}^{2} & ⋯ & {M}_{A 5}^{39} & {M}_{A 5}^{40} \\ {M}_{A 6}^{1} & {M}_{A 6}^{2} & ⋯ & {M}_{A 6}^{39} & {M}_{A 6}^{40}\end{matrix} ]$$

The processor 202 of the indoor positioner 102-1 combines the IQ sampling data of the Bluetooth beacon received by the antenna units A7, A8, and A9 in the third group to generate a reception parameter matrix (3), as follows.

$$[ \begin{matrix}{M}_{A 7}^{1} & {M}_{A 7}^{2} & ⋯ & {M}_{A 7}^{39} & {M}_{A 7}^{40} \\ {M}_{A 8}^{1} & {M}_{A 8}^{2} & ⋯ & {M}_{A 8}^{39} & {M}_{A 8}^{40} \\ {M}_{A 9}^{1} & {M}_{A 9}^{2} & ⋯ & {M}_{A 9}^{39} & {M}_{A 9}^{40}\end{matrix} ]$$

The processor 202 of the indoor positioner 102-1 combines the IQ sampling data of the Bluetooth beacon received by the antenna units A1, A4, and A7 in the fourth group to generate a reception parameter matrix (4), as follows.

$$[ \begin{matrix}{M}_{A 1}^{1} & {M}_{A 1}^{2} & ⋯ & {M}_{A 1}^{39} & {M}_{A 1}^{40} \\ {M}_{A 4}^{1} & {M}_{A 4}^{2} & ⋯ & {M}_{A 4}^{39} & {M}_{A 4}^{40} \\ {M}_{A 7}^{1} & {M}_{A 7}^{2} & ⋯ & {M}_{A 7}^{39} & {M}_{A 7}^{40}\end{matrix} ]$$

The processor 202 of the indoor positioner 102-1 combines the IQ sampling data of the Bluetooth beacon received by the antenna units A2, A5, and A8 in the fifth group to generate a reception parameter matrix (5), as follows.

$$[ \begin{matrix}{M}_{A 2}^{1} & {M}_{A 2}^{2} & ⋯ & {M}_{A 2}^{39} & {M}_{A 2}^{40} \\ {M}_{A 5}^{1} & {M}_{A 5}^{2} & ⋯ & {M}_{A 5}^{39} & {M}_{A 5}^{40} \\ {M}_{A 8}^{1} & {M}_{A 8}^{2} & ⋯ & {M}_{A 8}^{39} & {M}_{A 8}^{40}\end{matrix} ]$$

The processor 202 of the indoor positioner 102-1 combines the IQ sampling data of the Bluetooth beacon received by the antenna units A3, A6, and A9 in the sixth group to generate a reception parameter matrix (6), as follows.

$$[ \begin{matrix}{M}_{A 3}^{1} & {M}_{A 3}^{2} & ⋯ & {M}_{A 3}^{39} & {M}_{A 3}^{40} \\ {M}_{A 6}^{1} & {M}_{A 6}^{2} & ⋯ & {M}_{A 6}^{39} & {M}_{A 6}^{40} \\ {M}_{A 9}^{1} & {M}_{A 9}^{2} & ⋯ & {M}_{A 9}^{39} & {M}_{A 9}^{40}\end{matrix} ]$$

Then, the processor 202 of the indoor positioner 102-1 sends the reception parameter matrixes (1)-(6) corresponding to each of the groups to the MUSIC module 204 to calculate the angles of arrival from the user equipment (that is, the indoor positioning tag 104-2) to each of the groups of the antenna units. For example, angles of arrival θ₍₁₎ corresponding to the first group (the antenna units A1, A2 and A3), angles of arrival θ₍₂₎ corresponding to the second group (the antenna units A4, A5 and A6), angles of arrival θ₍₃₎ corresponding to the third group (the antenna units A7, A8 and A9), angles of arrival θ₍₄₎ corresponding to the fourth group (the antenna units A1, A4 and A7), angles of arrival θ₍₅₎ corresponding to the fifth group (the antenna units A2, A5 and A8), and angles of arrival θ₍₆₎ corresponding to the sixth group (the antenna units A3, A6 and A9) can be calculated. After that, the indoor positioner 102-1 sends the angles of arrival θ₍₁₎-θ₍₃₎ corresponding to the row (X axis) and the angles of arrival θ₍₄₎-θ₍₆₎ corresponding to the column (Y axis) to the statistic filter 206 to remove the angles of arrival that suffer multipath interference.

In some embodiments, when the indoor positioner 102-1 determines that the user equipment is in the stationary status, in order to increase the number of IQ sampling data of the Bluetooth beacon received by each of the groups of the antenna units, the indoor positioner 102-1 may sample 2 Bluetooth beacons, and combine the IQ sampling data to generate another reception parameter matrix. For example, the processor 202 of the indoor positioner 102-1 combines IQ sampling data from 2 Bluetooth beacons received by the antenna units A1, A2 and A3 in the first group to generate a reception parameter matrix (7) as follows.

$$[ \begin{matrix}{M}_{A 1}^{1} & {M}_{A 1}^{2} & ⋯ & {M}_{A 1}^{39} & {M}_{A 1}^{40} & {M}_{A 1}^{41} & {M}_{A 1}^{42} & ⋯ & {M}_{A 1}^{79} & {M}_{A 1}^{80} \\ {M}_{A 2}^{1} & {M}_{A 2}^{2} & ⋯ & {M}_{A 2}^{39} & {M}_{A 2}^{40} & {M}_{A 2}^{41} & {M}_{A 2}^{42} & ⋯ & {M}_{A 2}^{79} & {M}_{A 2}^{80} \\ {M}_{A 3}^{1} & {M}_{A 3}^{2} & ⋯ & {M}_{A 3}^{39} & {M}_{A 3}^{40} & {M}_{A 3}^{41} & {M}_{A 3}^{42} & ⋯ & {M}_{A 3}^{79} & {M}_{A 3}^{80}\end{matrix} ]$$

Wherein M_{A1}³⁹ indicates 39^{th} IQ sampling data received by the antenna unit A1, M_{A2}⁴¹ indicates 41^{st} IQ sampling data received by the antenna unit A2, and M_{A3}⁸⁰ indicates 80^{th} IQ sampling data received by the antenna unit A3. In other words, the processor 202 of the indoor positioner 102-1 may sample 40 sampling data in each Bluetooth beacon through the antenna units A1-A9.

The reception matrix (1) is a 3*40 matrix, and the reception matrix (7) is a 3*80 matrix. In other words, when the indoor positioner 102-1 determines that the user equipment is in the stationary status, the indoor positioner 102-1 may combine the IQ sampling data to generate a larger reception parameter matrix. For example, if the indoor positioner 102-1 combines the IQ sampling data that is received in 3 Bluetooth beacons, a 3*120 reception parameter matrix may be obtained.

Similarly, the processor 202 of the indoor positioner 102-1 combines IQ sampling data from two Bluetooth beacons received by the antenna units A4, A5 and A6 in the second group to generate a reception parameter matrix (8) as follows.

$$[ \begin{matrix}{M}_{A 4}^{1} & {M}_{A 4}^{2} & ⋯ & {M}_{A 4}^{39} & {M}_{A 4}^{40} & {M}_{A 4}^{41} & {M}_{A 4}^{42} & ⋯ & {M}_{A 4}^{79} & {M}_{A 4}^{80} \\ {M}_{A 5}^{1} & {M}_{A 5}^{2} & ⋯ & {M}_{A 5}^{39} & {M}_{A 5}^{40} & {M}_{A 5}^{41} & {M}_{A 5}^{42} & ⋯ & {M}_{A 5}^{79} & {M}_{A 5}^{80} \\ {M}_{A6}^{1} & {M}_{A 6}^{2} & ⋯ & {M}_{A 6}^{39} & {M}_{A 6}^{40} & {M}_{A 6}^{41} & {M}_{A 6}^{42} & ⋯ & {M}_{A 6}^{79} & {M}_{A 6}^{80}\end{matrix} ]$$

The processor 202 of the indoor positioner 102-1 combines IQ sampling data from two Bluetooth beacons received by the antenna units A7, A8 and A9 in the third group to generate a reception parameter matrix (9) as follows.

$$[ \begin{matrix}{M}_{A 7}^{1} & {M}_{A 7}^{2} & ⋯ & {M}_{A 7}^{39} & {M}_{A 7}^{40} & {M}_{A 7}^{41} & {M}_{A 7}^{42} & ⋯ & {M}_{A 7}^{79} & {M}_{A 7}^{80} \\ {M}_{A 8}^{1} & {M}_{A 8}^{2} & ⋯ & {M}_{A 8}^{39} & {M}_{A 8}^{40} & {M}_{A 8}^{41} & {M}_{A 8}^{42} & ⋯ & {M}_{A 8}^{79} & {M}_{A 8}^{80} \\ {M}_{A 9}^{1} & {M}_{A 9}^{2} & ⋯ & {M}_{A 9}^{39} & {M}_{A 9}^{40} & {M}_{A 9}^{41} & {M}_{A 9}^{42} & ⋯ & {M}_{A 9}^{79} & {M}_{A 9}^{80}\end{matrix} ]$$

The processor 202 of the indoor positioner 102-1 combines IQ sampling data from two Bluetooth beacons received by the antenna units A1, A4 and A7 in the fourth group to generate a reception parameter matrix (10) as follows.

$$[ \begin{matrix}{M}_{A 1}^{1} & {M}_{A 1}^{2} & ⋯ & {M}_{A 1}^{39} & {M}_{A 1}^{40} & {M}_{A 1}^{41} & {M}_{A 1}^{42} & ⋯ & {M}_{A 1}^{79} & {M}_{A 1}^{80} \\ {M}_{A 4}^{1} & {M}_{A 4}^{2} & ⋯ & {M}_{A 4}^{39} & {M}_{A 4}^{40} & {M}_{A 4}^{41} & {M}_{A 4}^{42} & ⋯ & {M}_{A 4}^{79} & {M}_{A 4}^{80} \\ {M}_{A 7}^{1} & {M}_{A 7}^{2} & ⋯ & {M}_{A 7}^{39} & {M}_{A 7}^{40} & {M}_{A 7}^{41} & {M}_{A 7}^{42} & ⋯ & {M}_{A 7}^{79} & {M}_{A 7}^{80}\end{matrix} ]$$

The processor 202 of the indoor positioner 102-1 combines IQ sampling data from two Bluetooth beacons received by the antenna units A2, A5 and A8 in the fifth group to generate a reception parameter matrix (11) as follows.

$$[ \begin{matrix}{M}_{A 2}^{1} & {M}_{A 2}^{2} & ⋯ & {M}_{A 2}^{39} & {M}_{A 2}^{40} & {M}_{A 2}^{41} & {M}_{A 2}^{42} & ⋯ & {M}_{A 2}^{79} & {M}_{A 2}^{80} \\ {M}_{A 5}^{1} & {M}_{A 5}^{2} & ⋯ & {M}_{A 5}^{39} & {M}_{A 5}^{40} & {M}_{A 5}^{41} & {M}_{A 5}^{42} & ⋯ & {M}_{A 5}^{79} & {M}_{A 5}^{80} \\ {M}_{A 8}^{1} & {M}_{A 8}^{2} & ⋯ & {M}_{A 8}^{39} & {M}_{A 8}^{40} & {M}_{A 8}^{41} & {M}_{A 8}^{42} & ⋯ & {M}_{A 8}^{79} & {M}_{A 8}^{80}\end{matrix} ]$$

The processor 202 of the indoor positioner 102-1 combines IQ sampling data from two Bluetooth beacons received by the antenna units A3, A6 and A9 in the sixth group to generate a reception parameter matrix (12) as follows.

$$[ \begin{matrix}{M}_{A 3}^{1} & {M}_{A 3}^{2} & ⋯ & {M}_{A 3}^{39} & {M}_{A 3}^{40} & {M}_{A 3}^{41} & {M}_{A 3}^{42} & ⋯ & {M}_{A 3}^{79} & {M}_{A 3}^{80} \\ {M}_{A 6}^{1} & {M}_{A 6}^{2} & ⋯ & {M}_{A 6}^{39} & {M}_{A 6}^{40} & {M}_{A 6}^{41} & {M}_{A 6}^{42} & ⋯ & {M}_{A 6}^{79} & {M}_{A 6}^{80} \\ {M}_{A 9}^{1} & {M}_{A 9}^{2} & ⋯ & {M}_{A 9}^{39} & {M}_{A 9}^{40} & {M}_{A 9}^{41} & {M}_{A 9}^{42} & ⋯ & {M}_{A 9}^{79} & {M}_{A 9}^{80}\end{matrix} ]$$

Then, the processor 202 of the indoor positioner 102-1 sends the reception parameter matrixes (7)-(12) to the MUSIC module 204 to calculate a plurality of angles of arrival from the user equipment (that is, the indoor positioning tags 104-2) to each of the groups of the antenna units. For example, angles of arrival θ₍₇₎ corresponding to the first group (the antenna units A1, A2 and A3), angles of arrival θ₍₈₎ corresponding to the second group (the antenna units A4, A5 and A6), angles of arrival θ₍₉₎ corresponding to the third group (the antenna units A7, A8 and A9), angles of arrival θ₍₁₀₎ corresponding to the fourth group (the antenna units A1, A4 and A7), angles of arrival θ₍₁₁₎ corresponding to the fifth group (the antenna units A2, A5 and A8), and angles of arrival θ₍₁₂₎ corresponding to the sixth group (the antenna units A3, A6 and A9) can be calculated. After that, the processor 202 of the indoor positioner 102-1 sends the angles of arrival θ₍₇₎-θ₍₉₎ corresponding to the row (X axis) and the angles of arrival θ₍₁₀₎-θ₍₁₂₎ corresponding to the column (Y axis) to the statistic filter 206 to remove the angles of arrival that suffer multipath interference.

The reception parameter matrix (1)-(12) are only examples, and are not intended to be limitations of the present invention.

FIG. 5 shows a schematic diagram of filtering a plurality of angles of arrival from X axis and from Y axis respectively by a statistic filter in accordance with some embodiments of the disclosure. In a specific embodiment, the statistic filter is a trim-mean filter. First, a statistic filter 500 sorts all the angles of arrival from X axis (e.g. θ₍₁₎-θ₍₃₎; θ₍₇₎-θ₍₉₎ , , , ) and from Y axis (e.g. θ₍₄₎-θ₍₆₎; θ₍₁₀₎-θ₍₁₂₎ , , , ) from small to large, then deletes the angles of arrival within a certain percentage of smallest and largest angles of arrival. For example, the smallest 10% of the angles of arrival and the largest 10% of the angles of arrival are deleted. Finally, the remaining angles of arrival are averaged. In this way, the angles of arrival that suffer multipath interference are filtered out.

For example, as shown in FIG. 5, the statistic filter 500 sorts the angles of arrival from X axis (e.g. θ₍₁₎-θ₍₃₎; θ₍₇₎-θ₍₉₎ , , , ) at time point t1 to obtain a sequence from X axis. Then, the statistic filter 500 deletes the smallest 10% and the largest 10% of the angles of arrival in the sequence, for example, the smallest angle of arrival θ₍₁₎ and the largest angle of arrival θ₍₉₎ are deleted. After that, the statistic filter 500 averages the remaining angles of arrival from X axis. Since new angles of arrival from the MUSIC module 204 are send into the statistic filter 500 in each time point, the statistic filter 500 use average filtering to delete the angles of arrival that does not meet the specifications, and to filter the angles of arrival that suffer multipath interference.

A processor of the positioning engine 106 converts the filtered angles of arrival from X axis and Y axis to position coordinates of the user equipment to complete the positioning action on the user equipment. In some embodiments, the statistic filter 206 can be implemented by the processor 202 of the indoor positioner 102-1. In some embodiments, the statistic filters 206, 500 can be executed by a processor of another SoC, but the present invention is not limited thereto. In the above embodiments, the angles of arrival θ₍₁₎-θ₍₆₎ are obtained by inputting 40 of IQ sampling data, and the angles of arrival θ₍₇₎-θ₍₁₂₎ are obtained by inputting 80 of IQ sampling data. However, the present invention does not limit the numbers of IQ sampling data that inputs into the MUSIC module 204.

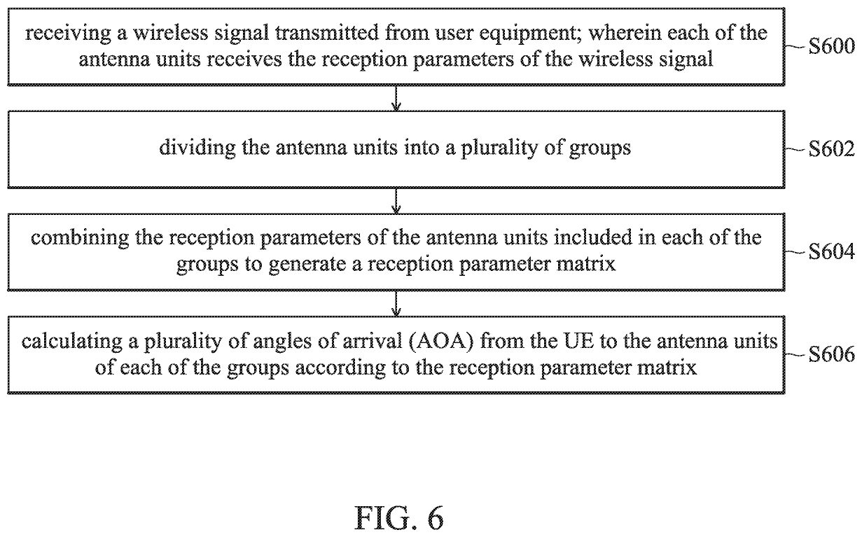

FIG. 6 shows a flow chart of an indoor positioning method in accordance with some embodiments of the disclosure. As shown in FIG. 6, the present invention discloses a method for indoor positioning, applicable to an electronic device comprising an array antenna and a processor, wherein the array antenna includes a plurality of antenna units, the method includes: receiving a wireless signal transmitted from user equipment (UE) (step S600), wherein each of the antenna units receives the reception parameters of the wireless signal; dividing the antenna units into a plurality of groups (step S602); combining the reception parameters of the antenna units included in each of the groups to generate a reception parameter matrix (step S604); and calculating a plurality of angles of arrival (AOA) from the UE to the plurality of the groups according to the reception parameter matrix (step S606).

In some embodiments, the step 602 is an optional step.

In some embodiments, the processor 202 of the indoor positioner 102-1 in FIG. 2 executes the steps S600, S602, S604 and S606. In some embodiments, the indoor positioners 102-1, 102-2, . . . , 102-n in FIG. 1 respectively have a storage device storing a code for executing the steps S600, S602, S604 and S606. The storage device also stores a MUSIC module 204 and a statistic filter 206. A processor of the positioning engine 106 in FIG. 1 converts the angles of arrival from X axis and Y axis obtained after the step S606 into position coordinates of the user equipment to complete the positioning action on the user equipment.

An electronic device and a method for indoor positioning disclosed in the present invention are based on a multiple signal classification (MUSIC) algorithm, and improve and optimize the Bluetooth wireless standard architecture, and then extended to develop a multiple linear sub-antenna for estimating the two-dimensional angles of arrival (DoA). The electronic device and the method disclosed in the present invention optimize the angle estimation through the front and back statistic filtering process, and achieve high-resolution two-dimensional signal angle of arrival (DoA) estimation technology. Antenna design, hardware complexity, software computing resource requirements, and execution speeds of the electronic device and the method disclosed in the present invention are significantly simpler and faster than those of the traditional MUSIC algorithm. In addition, the electronic device and the method disclosed in the present invention can filter out the multi-path effect, and accurately estimate a correct angle of arrival.

The ordinals in the specification and the claims of the present invention, such as “first”, “second”, “third”, etc., have no sequential relationship, and are just for distinguishing between two different components with the same name. In the specification of the present invention, the word “couple” refers to any kind of direct or indirect electronic connection. The present invention is disclosed in the preferred embodiments as described above, however, the breadth and scope of the present invention should not be limited by any of the embodiments described above. Persons skilled in the art can make small changes and retouches without departing from the spirit and scope of the invention. The scope of the invention should be defined in accordance with the following claims and their equivalents.

What is claimed is:

1. An electronic device, for indoor positioning, comprising:
an array antenna, comprising a plurality of antenna units, receiving a wireless signal transmitted from user equipment (UE); wherein each of the antenna units receives reception parameters of the wireless signal;
a processor, configured to execute the following tasks:
dividing the antenna units into a plurality of groups;
combining the reception parameters received by the antenna units included in each of the groups to generate a reception parameter matrix;
providing a multiple signal classification (MUSIC) module; and
calculating a plurality of angles of arrival (AOA) from the UE to the plurality of the groups according to the reception parameter matrix.

2. The electronic device as claimed in claim 1, wherein the processor further executes the following task:
filtering the angles of arrival to remove the angles of arrival that suffer multipath interference.

3. The electronic device as claimed in claim 1, wherein the processor divides the antenna units in the same row of the array antenna into the same group, and divides the antenna units in the same column of the array antenna into the same group.

4. The electronic device as claimed in claim 1, wherein status data of the user equipment are included on the wireless signal; the processor further executes the following task:
determining whether the user equipment is in a stationary state or in a moving state according to the status data.

5. The electronic device as claimed in claim 4, wherein the processor combines the reception parameters of the antenna units included in each of the groups to generate the reception parameter matrix according to the stationary state or the moving state of the user equipment.

6. A method for indoor positioning, applicable to an electronic device comprising an array antenna and a processor, wherein the array antenna comprises a plurality of antenna units, the method comprising:
receiving a wireless signal transmitted from user equipment (UE), wherein each of the antenna units receives the reception parameters of the wireless signal;
dividing the antenna units into a plurality of groups;
combining the reception parameters of the antenna units included in each of the groups to generate a reception parameter matrix;
calculating a plurality of angles of arrival (AOA) from the UE to the plurality of the groups according to the reception parameter matrix.

7. The method as claimed in claim 6, wherein dividing the antenna units into the plurality of groups comprises dividing the antenna units in the same row of the array antenna into the same group, and dividing the antenna units in the same column of the array antenna into the same group.

8. The method as claimed in claim 6, the method further comprising:
filtering the angles of arrival to remove the angles of arrival that suffer from multipath interference.

9. The method as claimed in claim 6, wherein status data of the user equipment are included on the wireless signal; wherein the method further comprises:
determining whether the user equipment is in a stationary state or a moving state according to the status data.

10. The method as claimed in claim 9, the method further comprising:
combining the reception parameters of the antenna units included in each of the groups to generate the reception parameter matrix according to the stationary state or the moving state of the user equipment.
